(19) United States
(12) Patent Application Publication
(10) Pub. No.: US 2014/0106317 A1
(43) Pub. Date: Apr. 17, 2014

(54) TEACHING RESOURCES FOR STUDYING MATHEMATICS HAVING THE EFFECT OF LEARNING BY REPETITION

(71) Applicant: Gap-Suk Choi, Seoul (KR)

(72) Inventor: Gap-Suk Choi, Seoul (KR)

(21) Appl. No.: 14/124,388

(22) PCT Filed: Dec. 26, 2011
(86) PCT No.: PCT/KR2011/010101

§ 371 Date: Dec. 6, 2013

(30) Foreign Application Priority Data
Jun. 8, 2011 (KR) 10 2011-0054896

(51) Int. Cl. G09B 23/02

(52) U.S. Cl. CPC G09B 23/02
USPC 434/191

(57) ABSTRACT

The present invention relates to a teaching resource for studying mathematics, and more specifically relates to a teaching resource for studying mathematics having the effect of learning by repetition, wherein the teaching resource comprises: a cardinal-number sheet constituted by repeatedly laying out a plurality of unit numbers on a layer of cardboard; and number-display inducing sheets each of which has at least one transparent window and is placed over the cardinal-number sheet so as to induce pre-determined study; being constituted in such a way that a plurality of the unit numbers laid out on the cardinal-number sheet are ex-posed in a limited fashion through the transparent windows of the number-display including sheets, such that children engaged in such study calculate problems by themselves following the basic rules of calculation, and, more particularly, such that said children can continuously and repeatedly study numerical problems of the same type while moving the transparent windows of the number-display inducing sheets.

### TECHNICAL FIELD

The present invention relates to a teaching material for studying mathematics, and more particularly, to a teaching material for studying mathematics with a repetitive learning effect, which includes: a cardinal number board on which a plurality of unit numbers are repetitively enumerated; and a number display sheet placed over the cardinal number board for inducing predetermined study and having at least one transparent window, such that the plural unit numbers laid out on the cardinal number board are restrictively exposed through the transparent window of the number display sheet placed over the cardinal number board, thereby enabling children to autonomously calculate problems according to the basic rules of calculation, and particularly enabling the children to continuously and repeatedly study numerical problems of the same type while moving the transparent windows of the number display sheets.

### BACKGROUND ART

In general, in order to make children basically learn the concepts of numbers and the four fundamental arithmetic operations which are the basics of mathematics, worksheets on each of which a lot of problems are written have been widely used.

Such a method of learning is to find right answers through training that children solve problems of arithmetic operations written on paper or a black board. In order to obtain a repeatedly studying effect, lots of problems of similar patterns or types are enumerated on one sheet of paper.

However, when children study using such a learning method by the worksheets, they recognize different problems as the same problems because explanation parts which are described for learners' better understanding are repeatedly written in spite of problems of the same structure, and hence, they often give up the worksheets after studying just the front part of the teaching material. The reason is that each of the problems has its own independent explanation in the teaching material.

Moreover, because the repeatedly described explanation parts occupy most of the studying space of the worksheet, the worksheets become thicker more than needs in the case that problems as needed to obtain a wanted studying effect are written, but it gives an impression of an increase of studying amount to students, and thus, it may be a main factor that the students lose their love of learning.

Therefore, recently, development of studying materials for mathematics which enable children to easily learn the concepts of numbers and the four fundamental arithmetic operations, make children get accustomed to operations, and improve children's arithmetic operation ability is keenly demanded.

### DISCLOSURE

### Technical Problem

Accordingly, the present invention has been made in an effort to solve the above-mentioned problems occurring in the prior arts, and it is an object of the present invention to provide a teaching material for studying mathematics with a repetitive learning effect, which includes: a cardinal number board on which a plurality of unit numbers are repetitively enumerated; and a number display sheet placed over the cardinal number board for inducing predetermined study and having at least one transparent window, thereby enabling children to autonomously and repeatedly calculate numbers restrictively exposed through the transparent windows of the number display sheets, out of the numbers enumerated on one sheet of the cardinal number board, according to the basic rules of calculation

It is another object of the present invention to provide a teaching material for studying mathematics with a repetitive learning effect, which makes children recognize the teaching material not as a learning tool but as a game board because just a plurality of unit numbers are repeatedly enumerated on the cardinal number board and there are no basic instructions or explanations on arithmetic operations and which enables the children to sufficiently study different problems of similar patterns or types just by the cardinal number board because combination of numbers selectively exposed through the transparent windows of the number display sheets on which learning methods are described and which are placed over the cardinal number board may be provided in various ways.

It is a further object of the present invention to provide a teaching material for studying mathematics with a repetitive learning effect, which maximizes a studying amount but minimizes the volume of worksheets because the repeated instructions or explanations of problems are excluded from the cardinal number board, such that children do not lose a love of studying because they do not have an impression that the teaching material has lots of studying amount.

In other words, the teaching material for studying mathematics according to an exemplary embodiment of the present invention is to enhance studying efficiency.

### Technical Solution

To achieve the above objects, the present invention provides a teaching material for studying mathematics including: a cardinal number board repeatedly enumerating a plurality of unit numbers; and a number display sheet having at least one transparent window placed over the cardinal number board for inducing predetermined learning, such that some of the plural unit numbers of the cardinal number board are restrictively exposed through the transparent window of the number display sheet, wherein another unit number is exposed through the transparent window when a learner moves the number display sheet placed over the cardinal number board, so that the learner can repeatedly and continuously study arithmetic operations of the same type.

Moreover, the transparent window of the number display sheet continuously exposes adjacent two numbers which indicate a two-digit number, out of the plural unit numbers of the cardinal number board.

Furthermore, the transparent window of the number display sheet is formed in a “ [symbol] ” shape in order to continuously expose adjacent two numbers which indicate a two-digit number and a number which indicates a single-digit number placed beneath the two-digit number, out of the plural unit numbers of the cardinal number board.

Additionally, at a blank space of the left side of the “ [symbol] ”-shaped transparent window, the number display sheet selectively has “o” for indicating that the unit number exposed through the transparent window of the lower part is a single-digit number or one of natural numbers, “1, 2, 3, 4, 5, 6, 7, 8, and 9”, for indicating a two-digit number, and one of the symbols of operation (+, −, × or ÷) for arithmetically operating the two-digit number exposed through the transparent windows of the upper part and the single-digit number exposed through the transparent window of the lower part.

In addition, a pair of first and second transparent windows are spaced away from each other on the number display sheet for respectively exposing two spaced numbers out of the plural unit numbers of the cardinal number board.

Moreover, the first and second transparent windows spaced away from each other on the number display sheet are in a vertical bar shape.

Furthermore, the number display sheet having the first and second transparent windows spaced away from each other selectively has one of the symbols of operation (+, −, × or ÷) between the first and second transparent windows.

Additionally, the number display sheet having the first and second transparent windows spaced away from each other selectively has a number with a decimal point or a number in the tens place at the left side of the first and second transparent windows so as to enhance the level of difficulty in studying.

In addition, the number display sheet having the first and second transparent windows spaced away from each other has a number, “5”, which is in the units place at the right side of the first and second transparent windows so as to indicate that the unit number exposed through the first and second transparent windows is in the tens place.

Moreover, the number display sheet has a fraction indication part for inducing applied learning on fractions and separated first and second transparent windows for selectively exposing denominator parts or numerator parts of the fractions.

Furthermore, the number display sheet comprises: transparent windows for exposing at least two continued numbers out of the plural unit numbers of the cardinal number board; and a number indicated at the right side of the transparent windows and coinciding with the exposed number of the transparent window to make a number in tens (20, 30, . . . ), such that the learner can study arithmetic operations of defective numbers to make the sum of the exposed number become 20 or 30.

Additionally, the number display sheet comprises: a transparent window for exposing one of the plural unit numbers of the cardinal number board; and a square root indicated at the right top of the transparent window, such that the learner can study arithmetic operations of square roots of the exposed number.

### Advantageous Effects

According to the exemplary embodiment of the present invention, the teaching material for studying mathematics, which includes: a cardinal number board on which a plurality of unit numbers are repetitively enumerated; and a number display sheet placed over the cardinal number board for inducing predetermined study and having at least one transparent window, enables children to autonomously and repeatedly calculate numbers restrictively exposed through the transparent windows of the number display sheets, out of the numbers enumerated on one sheet of the cardinal number board, according to the basic rules of calculation.

Furthermore, the teaching material for studying mathematics with a repetitive learning effect makes children recognize the teaching material not as a learning tool but as a game board because just a plurality of unit numbers are repeatedly enumerated on the cardinal number board and there are no basic instructions or explanations on arithmetic operations, and enables the children to sufficiently study different problems of similar patterns or types just by the cardinal number board because combination of numbers selectively exposed through the transparent windows of the number display sheets on which learning methods are described and which are placed over the cardinal number board may be provided in various ways.

Additionally, the teaching material for studying mathematics according to the exemplary embodiment of the present invention maximizes a studying amount but minimizes the volume of worksheets because the repeated instructions or explanations of problems are excluded from the cardinal number board, such that children do not lose a love of studying and remarkably enhance studying efficiency because they do not have an impression that the teaching material has lots of studying amount.

### DESCRIPTION OF DRAWINGS

FIG. 1 is a perspective view showing a structure of a teaching material for studying mathematics according to a preferred embodiment of the present invention.

FIGS. 2a to 2d is views which respectively show structures of number display sheets having bent-shaped transparent windows according to a preferred embodiment of the present invention.

FIGS. 3a to 3g are views which respectively show structures of number display sheets having vertically bar-shaped transparent windows according to a preferred embodiment of the present invention.

FIGS. 4a and 4b are views which respectively show structures of number display sheets having transparent windows for inducing applied studying of fractions or mixed numbers according to a preferred embodiment of the present invention.

FIGS. 5a and 5b are views which respectively show structures of number display sheets having transparent windows for inducing a learner's arbitrary applied studying according to a preferred embodiment of the present invention.

FIG. 6 is a view showing a structure of a number display sheet for inducing applied studying of square numbers according to a preferred embodiment of the present invention.

FIGS. 7a and 7b are views showing examples of various cardinal number boards according to a preferred embodiment of the present invention.

### MODE FOR INVENTION

Reference will be now made in detail to the preferred embodiment of the present invention with reference to the attached drawings.

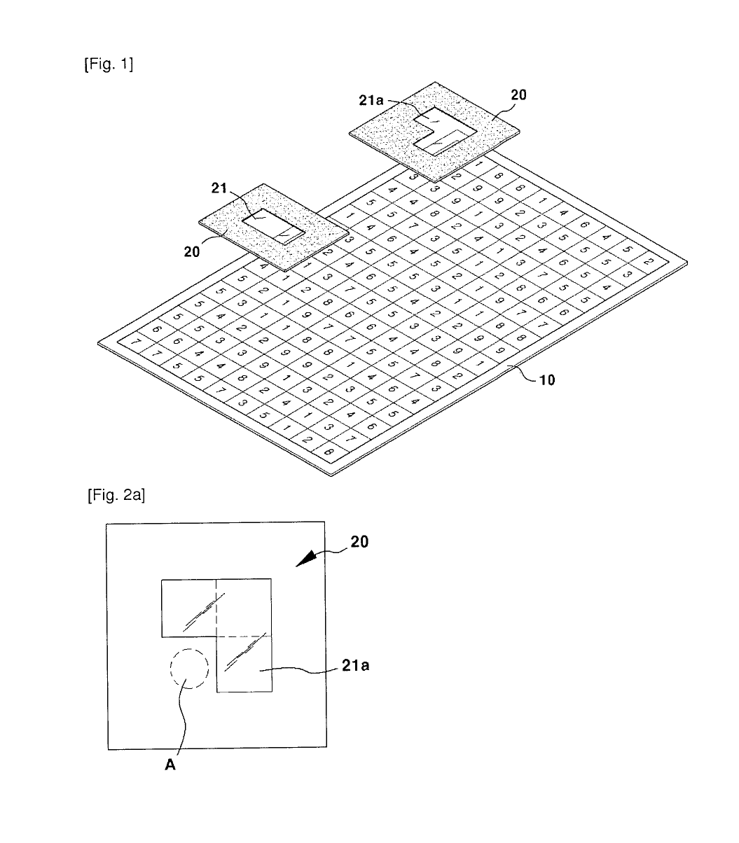

FIG. 1 is a perspective view showing a structure of a teaching material for studying mathematics according to a preferred embodiment of the present invention. The teaching material for studying mathematics according to the preferred embodiment of the present invention includes a cardinal number board 10 and a number display sheet 20.

The cardinal number board 10 includes a plurality of unit numbers repeatedly enumerated on a board. The cardinal number board 10 densely enumerates the plural unit numbers in vertical and horizontal directions so as to maximize a range of arithmetic operations by combination of the numbers.

The number display sheet 20 is moved in a state where it is laid on the cardinal number board 10 or is placed over the cardinal number board 10 in order to induce predetermined studying. The number display sheet 20 includes at least one transparent window 21 in order to induce applied studying of arithmetic operations of various kinds on mathematical problems using the numbers repeatedly enumerated on the cardinal number board 10.

That is, children who are learners can autonomously calculate numbers restrictively exposed through the transparent window 21, out of the numbers densely enumerated on the cardinal number board 10, according to the basic rules of calculation and repeatedly study arithmetic operations through combination of the number display sheets 20 having at least one transparent window 21.

In this instance, as shown in FIG. 1, the transparent window 21 may be formed in a straight shape having at least one cell in order to expose the numbers, which are repeatedly enumerated on the cardinal number board 10, as at least one digit number.

In other words, in the case that the number display sheet 20 has the straight-shaped transparent window 21, the transparent window 21 restrictively exposes at least one number of the repeatedly enumerated numbers when the number display sheet 20 is moved above the cardinal number board 10, and thus, the children recognize the teaching material as a game board because there is no the basic instruction or explanation on the arithmetic operation and study the four fundamental arithmetic operations, namely, addition (+), subtraction (−), multiplication (×) and/or division (÷) in various game methods using at least one number restrictively exposed through the transparent window 21, repeatedly study the arithmetic operations or repeatedly study various modified problems of the same type.

As an example, in the case that the straight-shaped transparent window 21 has two continued cells, when the learner lays the number display sheet 20 on the cardinal number board 10, just two numbers are restrictively exposed side by side through the transparent window 21, such that the learner can study various operations by adding, subtracting, multiplying or dividing the two numbers exposed restrictively, and repeatedly study the arithmetic operations or repeatedly study various modified problems of the same type.

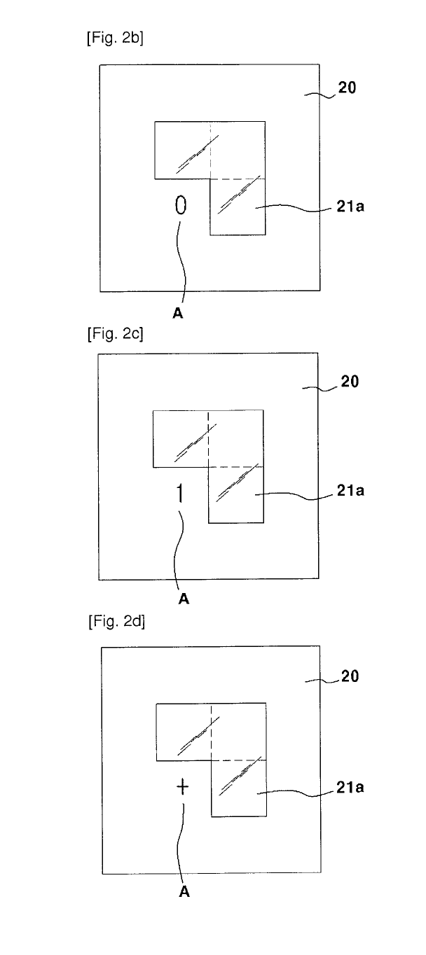

In the meantime, as shown in FIG. 2a, in the case that the number display sheet 20 has a bent transparent window, namely, a ‘ [symbol] ’-shaped transparent window 21a, numbers repeatedly enumerated on the cardinal number board 10 are restrictively exposed as two-digit numbers through the transparent window 21a and a single-digit number is continuously exposed beneath the two-digit number through the transparent window 21a, such that the learner can study the arithmetic operations (addition, subtraction, multiplication and/or division) in various ways and repeatedly study applied learning.

In this instance, as shown in FIG. 2a, the number display sheet 20 does not have any symbol indicated at a blank space A of the left side of the ‘ [symbol] ’-shaped transparent window 21a, such that the learner can autonomously repeat his or her wanted studying by arbitrarily defining the two-digit number of the upper part and the single-digit number of the lower part which are exposed through the transparent window 21a.

However, as shown in FIGS. 2b to 2d, the number display sheet 20 may have a number (0 or 1) or one of the symbols of operation (+, −, × or ÷), for the applied studying of mathematical operations, which is restrictively exposed at the blank space through the ‘ [symbol] ’-shaped transparent window 21a so as to induce studying in various manners.

FIG. 2b illustrates a state where the number, “0”, is indicated at the blank space A of the left side of the ‘ [symbol] ’-shaped transparent window 21a, and hence, the learner can recognize that the single-digit number exposed through the transparent window is in the units place and that the number which is in the tens place is “0”. Therefore, through the basic studying, the learner sufficiently recognizes the single-digit numbers and two-digit numbers. After that, as shown in FIG. 2c, using the number display sheet 20 on which one of “1, 2, 3, 4, 5, 6, 7, 8 and 9” which is in the tens place is selectively written at the blank space A of the left side of the ‘ [symbol] ’-shaped transparent window 21a, the learner can study arithmetic operations of two-digit numbers.

Of course, the number display sheet 20 may selectively have the symbols of operation (+, −, × or ÷) at the blank space A of the left side of the ‘ [symbol] ’-shaped transparent window 21a so as to concretely show the contents to be studied to the learner.

As described above, the number display sheet 20 shown in FIGS. 2b to 2d restrictively exposes just numbers through the transparent window 21a but does not have any instruction or explanation on the arithmetic operation of the numbers exposed, and thus, the learner can do studying of various kinds by defining the restrictively exposed numbers by one of the numbers or one of the symbols of operation. Moreover, the learner can widely, freely and repeatedly study various problems for applied learning by means of combination of numbers restrictively exposed through the transparent window 21a.

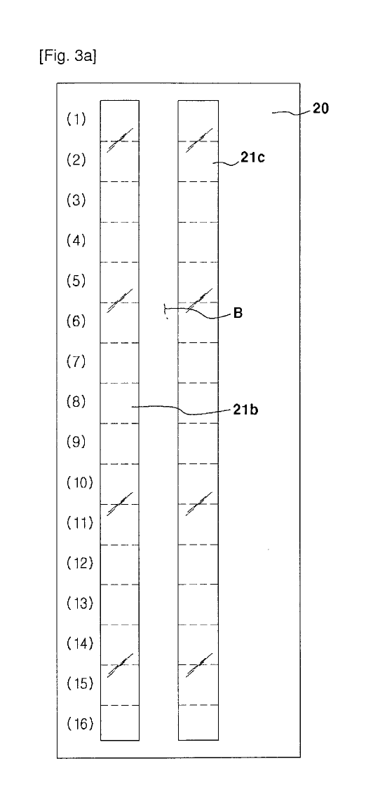

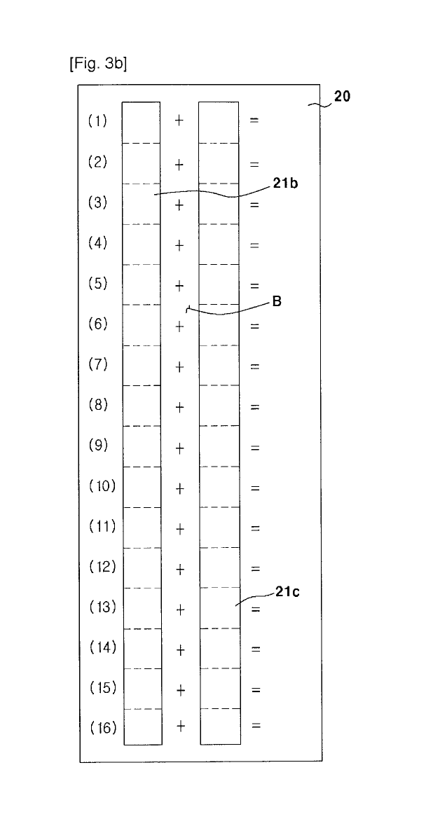

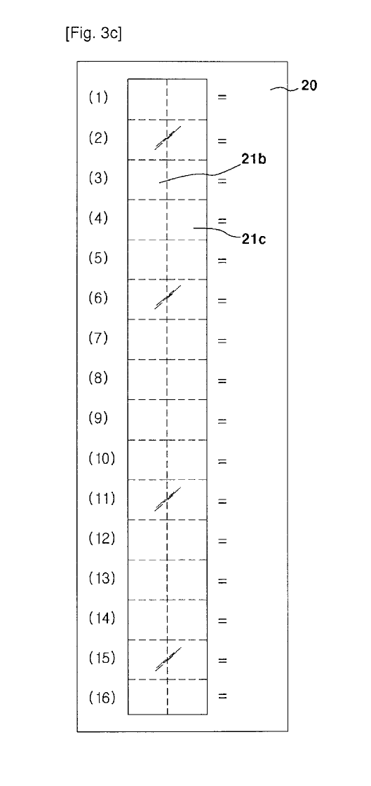

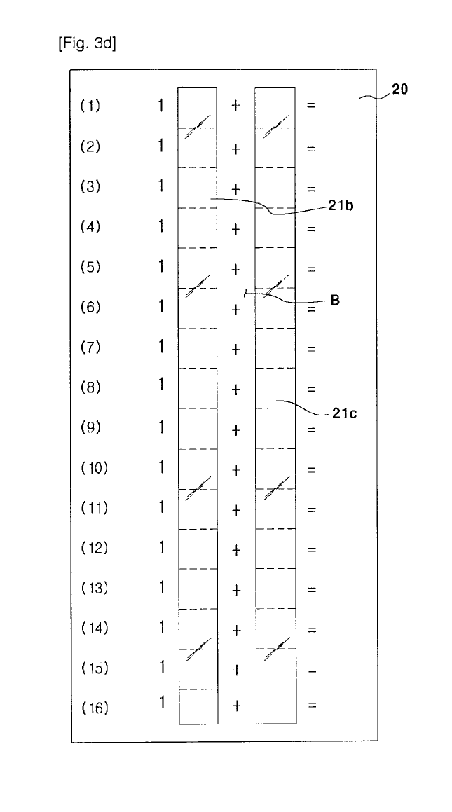

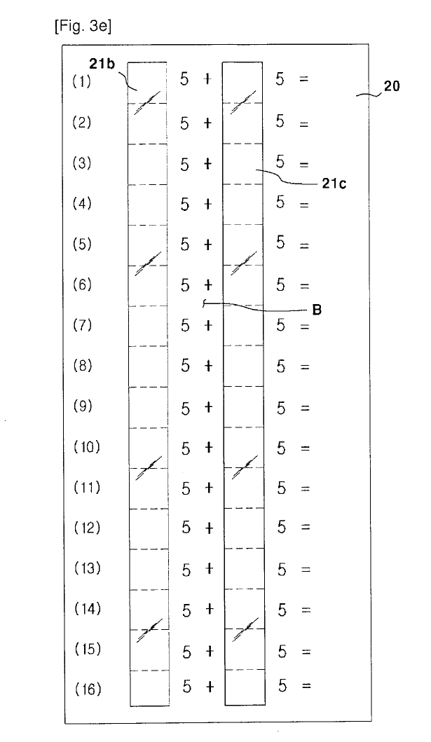

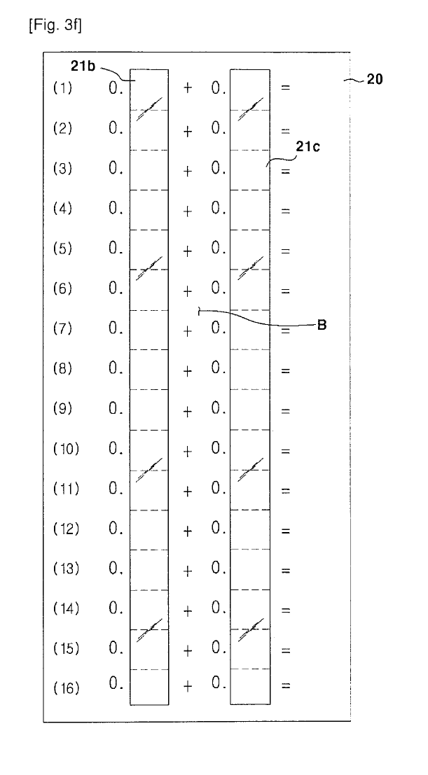

Meanwhile, as shown in FIGS. 3a to 3g, the number display sheet 20 may have a size to continuously cover some of the cardinal number board 10. In this instance, the number display sheet 20 includes a pair of first and second transparent windows 21b and 21c of a vertical bar shape, such that the learner can do applied learning of various operations through numbers continuously exposed through the first and second transparent windows 21b and 21c and study various modified problems of the same type through selective combination of numbers.

As an example, as shown in FIG. 3c, in the case that the first and second transparent windows 21b and 21c are formed side by side, the two adjacent numbers on the cardinal number board 10 are restrictively exposed through the first and second transparent windows 21b and 21c, such that the learner can do the four fundamental arithmetic operations by adding, subtracting, multiplying or dividing the two adjacent numbers or can do the four fundamental arithmetic operations of a modified type by selectively combining numbers of the upper and the lower part, such that the learner can repeatedly study problems of the four fundamental arithmetic operations in various ways like a game without feeling boredom.

Moreover, as shown in FIG. 3a, a pair of the first and second transparent windows 21b and 21c may be formed in a vertical bar shape and spaced at a predetermined interval from each other side by side such that two numbers of the cardinal number board 10 are vertically and continuously exposed at a predetermined interval, such that the learner can do applied learning of the four fundamental arithmetic operations using the two numbers restrictively exposed through the first and second transparent windows 21b and 21c at the predetermined interval or can do modified arithmetic operations of the same type by selectively combining the numbers.

In the meantime, as shown in FIG. 3b, the number display sheet 20 having the first and second transparent windows 21b and 21c which are arranged side by side at a predetermined interval may have one of the symbols of operation (+, −, × or ÷) at a blank space B of the number display sheet 20, such that the learner can do the arithmetic operations by adding, subtracting, multiplying or dividing the numbers exposed through the transparent windows 21b and 21c using the symbols of operation (+, −, × or ÷) or can do modified arithmetic operations of the same type by selectively combining the numbers.

Furthermore, as shown in FIG. 3d, the number display sheet 20 having the first and second transparent windows 21b and 21c of the bar shape may have one of numbers which is in the tens place, such that the learner can study operations of two-digit numbers using the number exposed through the first transparent window 21b which shows a number in the tens place by adding, subtracting, multiplying or dividing with the number exposed through the second transparent window 21c using the symbols of operation (+, −, × or ÷) or can do modified arithmetic operations of the same type by selectively combining the numbers.

Additionally, as shown in FIG. 3e, a number in units may be indicated at the blank space B formed between the first and second transparent windows 21b and 21c, such that a number exposed through the first and second transparent windows 21b and 21c becomes a number in the tens place, and of course, the symbols of operation (+, −, × or ÷) may be selectively indicated.

In other words, when “5” which is a single-digit number is indicated at the right side part of the first and second transparent windows 21b and 21c, because the numbers restrictively exposed through the first and second transparent windows 21b and 21c become numbers in the tens place, and of course, the symbols of operation (+, −, × or ÷) may be selectively indicated.

Moreover, as shown in FIG. 3f, not only at the left side part of the first and second transparent windows 21b and 21c but also at the blank space B, a number with a decimal point and one of the symbols of operation may be indicated, such that the learner can do arithmetic operations of decimals by adding, subtracting, multiplying or dividing the number having the decimal point with the number exposed through the first and second transparent windows 21b and 21c using the symbols of operation (+, −, × or ÷) or can do modified arithmetic operations of the same type by selectively combining the numbers.

Meanwhile, as shown in FIG. 3g, the number display sheet may include first and second transparent windows 21b and 21c arranged side by side in order to simultaneously expose two continued numbers and a third transparent window 21d arranged at the right side part of the first and second transparent windows 21b and 21c and spaced apart from the first and second transparent windows 21b and 21c at a predetermined interval, and may further include one of the symbols of operation (+, −, × or ÷) formed at the blank space B formed between the first and second transparent windows 21b and 21c and the third transparent window 21d, such that the learner can do arithmetic operations by adding, subtracting, multiplying or dividing the double-digit number restrictively exposed through the first and second transparent windows 21b and 21c and the single-digit number restrictively exposed through the third transparent window 21d using the symbols of operation (+, −, × or ÷).

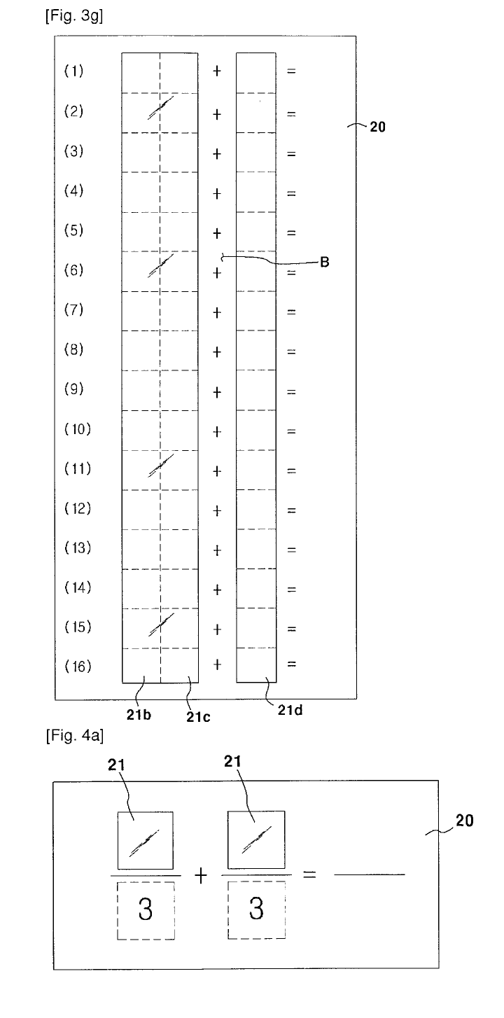

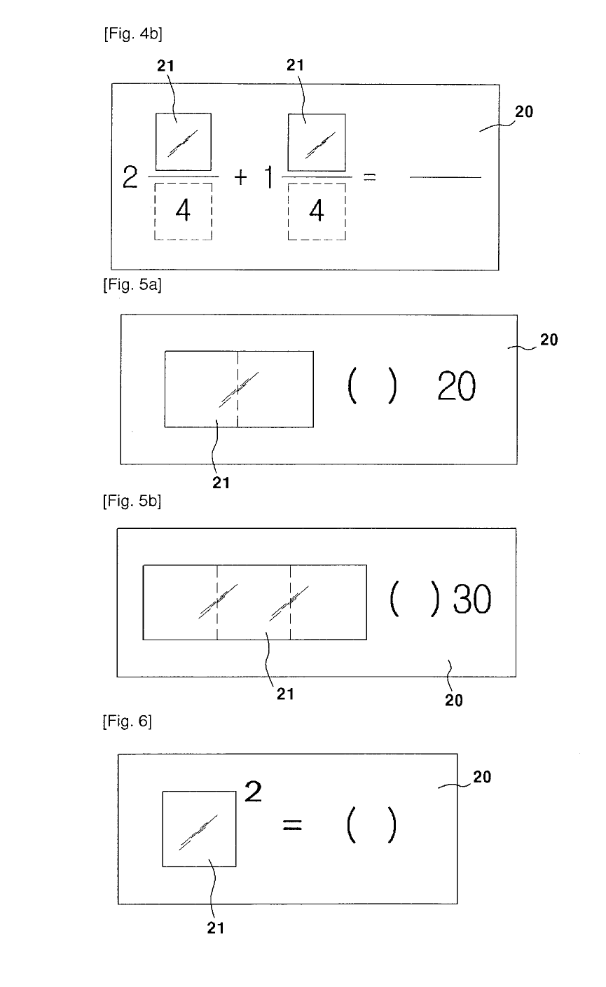

In the meantime, as shown in FIGS. 4a and 4b, the number display sheet 20 may include a mathematical operation expression for inducing applied learning of fractions or mixed numbers and transparent windows 21 formed at a denominator part or a numerator part of the indicated fraction or mixed number, such that the learner can study arithmetic operations of fractions or mixed numbers.

In other words, when the learner moves the number display sheet 20 over the cardinal number board 10, various numbers are restrictively exposed through the transparent windows 21 formed at the numerator part, such that the learner can do applied learning of various problems of fractions or mixed numbers through changes in numbers restrictively exposed through the transparent windows 21.

Meanwhile, as shown in FIGS. 5a and 5b, the number display sheet 20 may include at least one transparent window for exposing a number of the cardinal number board 10, a blank space D formed at the right side part of the transparent window 21 for allowing the learner to arbitrarily fill out a number, and a number indicated side by side with the blank space D. When the learner moves the number display sheet 20 over the cardinal number board 10, at least one number of the cardinal number board 10 is restrictively exposed through the transparent window 21, and in this instance, when the learner fills out one of the symbols of operation (+, −, × or ÷) in the blank space D, the learner can study arithmetic operations by adding, subtracting, multiplying or dividing the number restrictively exposed through the transparent window 21 with the number fixedly indicated at the right side part of the number display sheet 20 while moving the number display sheet 20 according to the changed symbols of operation (+, −, × or ÷).

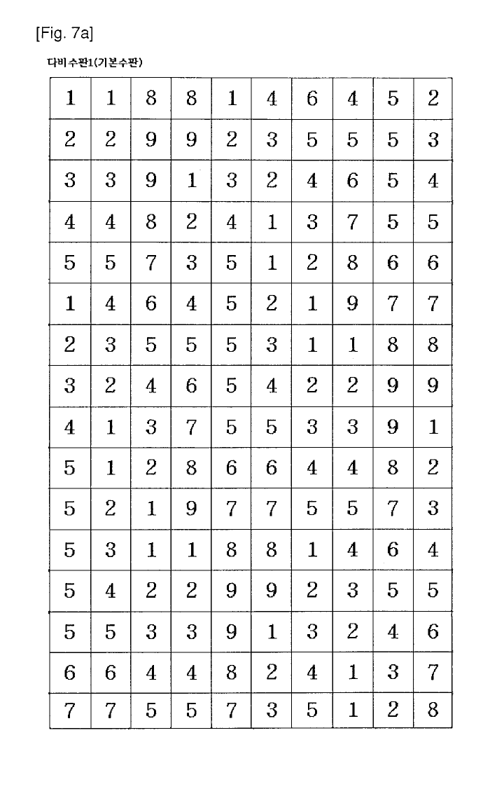

In the meantime, as shown in FIG. 6, the number display sheet 20 may include a transparent window 21 having a square number, such that the learner can study arithmetic operations of various square numbers whenever the learner moves the number display sheet 20 over the cardinal number board 10.

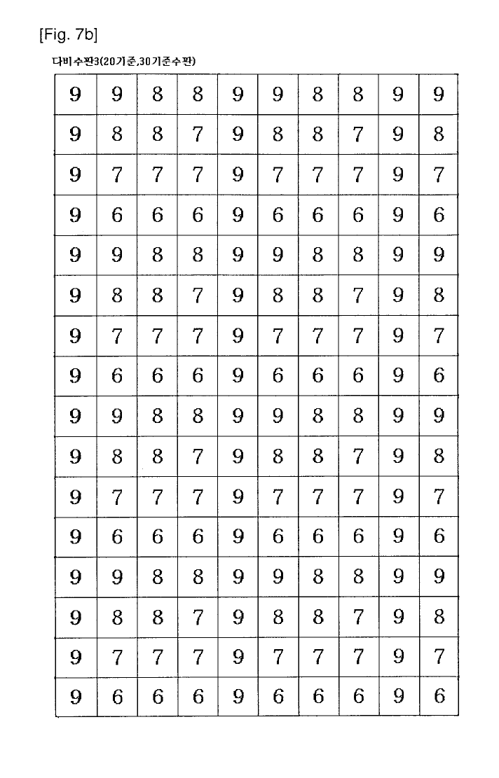

FIGS. 7a and 7b illustrate an example of the cardinal number board 10. As shown in FIG. 7a, from the top of the left side, the cardinal number board 10 for the basic studying has the same numbers whose sum does not exceed 10 (1.1, 2.2, 3.3, 4.4, and 5.5), numbers whose sum becomes 5 (1.4, 2.3, 3.2, and 4.1), numbers increased by one from 5 (5.1, 5.2, 5.3, 5.4, and 5.5), the same numbers whose sum exceed 10 (5.5, 6.6, 7.7, 8.8, and 9.9), numbers whose sum becomes 10 (9.1, 8.2, 7.3, 6.4, 5.5, 4.6, 3.7, 2.8, and 1.9) continuously repeated in order.

Therefore, the learner can repeatedly study the basic operations in various ways as if he or she plays a game while hiding the unit numbers of the cardinal number board 10 using the number display sheet 20 having the two continued transparent windows 21.

On the contrary, the cardinal number board 10 for studying numbers to make tens (20, 30, . . . ) may be constructed as shown in FIG. 7b.

Numbers which exceed 5 are enumerated on the cardinal number board 10, and hence, the learner thinks a complement number to make the sum of each unit number become 10 and adds the sum of the complement number to the sum of the numbers exposed through the transparent windows 21 of the number display sheet 20 so as to make numbers in tens (20, 30, . . . ). The learner can repeatedly study the above operation.

As described above, in the state where regular numbers or irregular numbers are indicated on the cardinal number board 10, when the number display sheet 20 is placed or moved over the cardinal number board 10 or the number display sheet 20 having the same size as the cardinal number board is laid on the cardinal number board 10, the learner can solve various problems of applied learning for adding, subtracting, multiplying or dividing numbers exposed through the transparent windows 21, 21a, 21b, 21c, 21d and 21e of the number display sheet 20 using the symbols of operation (+, −, × or ÷) without feeling boredom and can solve various problems of applied learning on numbers having decimal points.

### INDUSTRIAL APPLICABILITY

While the particular embodiments of the present invention have been particularly described in this specification of the present invention and shown with reference to the attached drawings, it should be understood that there is no intent to limit the example embodiments of the present invention to the particular forms disclosed, but on the contrary, example embodiments of the invention are to cover all modifications, equivalents, and alternatives falling within the spirit and scope of the invention defined by the claims.

What is claimed:

1. A teaching material for studying mathematics with a repetitive learning effect comprising:
a cardinal number board repeatedly enumerating a plurality of unit numbers; and
a number display sheet having at least one transparent window placed over the cardinal number board for inducing predetermined learning, such that some of the plural unit numbers of the cardinal number board are restrictively exposed through the transparent window of the number display sheet,
wherein another unit number is exposed through the transparent window when a learner moves the number display sheet placed over the cardinal number board, so that the learner can repeatedly and continuously study arithmetic operations of the same type.

2. The teaching material according to claim 1, wherein the transparent window of the number display sheet continuously exposes adjacent two numbers which indicate a two-digit number, out of the plural unit numbers of the cardinal number board.

3. The teaching material according to claim 1, wherein the transparent window of the number display sheet is formed in a “ [symbol] ” shape in order to continuously expose adjacent two numbers which indicate a two-digit number and a number which indicates a single-digit number placed beneath the two-digit number, out of the plural unit numbers of the cardinal number board.

4. The teaching material according to claim 3, wherein at a blank space of the left side of the “ [symbol] ”-shaped transparent window, the number display sheet selectively has “o” for indicating that the unit number exposed through the transparent window of the lower part is a single-digit number or one of natural numbers, “1, 2, 3, 4, 5, 6, 7, 8, and 9”, for indicating a two-digit number, and one of the symbols of operation (+, −, × or ÷) for arithmetically operating the two-digit number exposed through the transparent windows of the upper part and the single-digit number exposed through the transparent window of the lower part.

5. The teaching material according to claim 1, wherein a pair of first and second transparent windows are spaced away from each other on the number display sheet for respectively exposing two spaced numbers out of the plural unit numbers of the cardinal number board.

6. The teaching material according to claim 5, wherein the first and second transparent windows spaced away from each other on the number display sheet are in a vertical bar shape.

7. The teaching material according to claim 5, wherein the number display sheet having the first and second transparent windows spaced away from each other selectively has one of the symbols of operation (+, −, × or +) between the first and second transparent windows.

8. The teaching material according to claim 5, wherein the number display sheet having the first and second transparent windows spaced away from each other selectively has a number with a decimal point or a number in the tens place at the left side of the first and second transparent windows so as to enhance the level of difficulty in studying.

9. The teaching material according to claim 5, wherein the number display sheet having the first and second transparent windows spaced away from each other has a number, “5”, which is in the units place at the right side of the first and second transparent windows so as to indicate that the unit number exposed through the first and second transparent windows is in the tens place.

10. The teaching material according to claim 5, wherein the number display sheet has a fraction indication part for inducing applied learning on fractions and separated first and second transparent windows for selectively exposing denominator parts or numerator parts of the fractions.

11. The teaching material according to claim 1, wherein the number display sheet comprises: transparent windows for exposing at least two continued numbers out of the plural unit numbers of the cardinal number board; and a number indicated at the right side of the transparent windows and coinciding with the exposed number of the transparent window to make a number in tens (20, 30, . . . ), such that the learner can study arithmetic operations of defective numbers to make the sum of the exposed number become 20 or 30.

12. The teaching material according to claim 1, wherein the number display sheet comprises: a transparent window for exposing one of the plural unit numbers of the cardinal number board; and a square root indicated at the right top of the transparent window, such that the learner can study arithmetic operations of square roots of the exposed number.

13. The teaching material according to claim 6, wherein the number display sheet having the first and second transparent windows spaced away from each other selectively has one of the symbols of operation (+, −, × or ÷) between the first and second transparent windows.

14. The teaching material according to claim 6, wherein the number display sheet having the first and second transparent windows spaced away from each other selectively has a number with a decimal point or a number in the tens place at the left side of the first and second transparent windows so as to enhance the level of difficulty in studying.

15. The teaching material according to claim 6, wherein the number display sheet having the first and second transparent windows spaced away from each other has a number, “5”, which is in the units place at the right side of the first and second transparent windows so as to indicate that the unit number exposed through the first and second transparent windows is in the tens place.
